(19) United States
(12) Patent Application Publication
(10) Pub. No.: US 2020/0252237 A1
(43) Pub. Date: Aug. 6, 2020

(54) SYSTEMS AND METHODS FOR IDENTIFYING COMPONENTS ON A COMMUNICATIONS BUS

(71) Applicant: ZUME, INC., Mountain View, CA (US)

(72) Inventor: Joshua Gouled GOLDBERG, Mountain View, CA (US)

(21) Appl. No.: 16/641,884

(22) PCT Filed: Aug. 23, 2018
(86) PCT No.: PCT/US2018/047767

§ 371 Date: Feb. 25, 2020

Related U.S. Application Data
(60) Provisional application No. 62/550,438, filed on Aug. 25, 2017.

(51) Int. Cl. H04L 12/40; H04W 48/10

(52) U.S. Cl. CPC H04L 12/40182; H04L 12/40189; H04L 2012/40273; H04L 2012/40215; H04W 48/10

(57) ABSTRACT

Systems and networks are disclosed in which node addresses are requested by and/or assigned to components communicatively coupled to a communications network. The node addresses may be used by the components to transmit and receive data and other information with other components communicatively coupled to the communications network. Additional information regarding such components, such as, for example, location information for each communicatively coupled component may be maintained. Such information may be used to maintain the status of the communications network and may include physical location information, which may be determined based on data obtained from sensing components (e.g., imagers).

### TECHNICAL FIELD

This description generally relates to components deployed in a communication network.

### DESCRIPTION OF THE RELATED ART

Communication busses may be used to communicatively couple one or more components into a communication network, thereby enabling the various components to transmit and receive data and other information with one another. The ability to communicate may be particularly useful in situations in which the various components work together to perform a task or function, such as may the case, for example, in an automated environment in which various units perform various tasks related to preparing and/or manufacturing items. The ability for each of the components to function together, however, may be hindered by communications busses that do not provide needed information (e.g., location information) about the various components.

### BRIEF SUMMARY

A communications network may include a processor that assigns node addresses (e.g., network node address) to components communicatively coupled to the network. The node addresses may be used by the components to transmit and receive data and other information with other components communicatively coupled to the communications network. A database may be used to maintain additional information regarding such components, such as, for example, location information for each communicatively coupled component. Such location information may be determined based on data obtained from other sensing components (e.g., images from an imager, sound data from a microphone).

A system to operate with a plurality of components which are selectively positionable in respective spaces of an array of spaces may be summarized as including: at least one sensor positioned to monitor one or more components when the one or more components are positioned in the respective spaces of the array of spaces; at least one processor communicatively coupled to the at least one sensor to receive signals therefrom; at least one processor-readable medium communicatively coupled to the at least one processor and that stores processor-executable instructions, the processor-executable instructions, which when executed by the at least one processor, cause the at least one processor to: for each of a number of the components, in response to a detection of a detectable controllable action from one of the components, store a relationship between a physical location of the space in the array of spaces in which the respective component is positioned and a node address via which the respective component is addressed on a communications network, the communications network including one or more nodes that are communicatively coupleable to respective ones of the plurality of components.

The instructions, when executed by the at least one processor, may further cause the at least one processor to cause the component to perform the detectable controllable action. The instructions, when executed by the at least one processor, may cause the at least one processor to cause the component to produce at least one of a manifestation, a signal, and an indication as the detectable controllable action. The instructions, when executed by the at least one processor, may cause the at least one processor to cause the component to at least one of activate or deactivate a light, produce an output of a display screen, generate an aural output, generate a tactile output, open or close a door, or change in temperature. The instructions, when executed by the at least one processor, may cause the at least one processor to query the components for the respective node addresses. The node addresses may be randomly generated at the components, and the instructions, when executed by the at least one processor, may cause the at least one processor to check for collisions between the randomly generated node addresses received from the components, and in response to detection of a collision between at least two of the received node addresses, may cause a random generation of at least one new node address. The node addresses may be randomly generated at the components, and the instructions, when executed by the at least one processor, may cause the at least one processor to check for collisions between the randomly generated node addresses received from the components, and may, in response to detection of a collision between at least two of the received node addresses, cause a random generation of new node addresses for each of the components. The instructions, when executed by the at least one processor, may cause the at least one processor to rebroadcast the query to all nodes on the communications network in order to cause the random generation of at least one new node address. The instructions, when executed by the at least one processor, may cause the at least one processor to broadcast the query to all nodes on the communications network. The instructions, when executed by the at least one processor, may cause the at least one processor to receive the respective node addresses for the components from the components. The query may occur during an addressing mode of operation. The communications network may be a physical communications bus, and the instructions, when executed by the at least one processor, may cause the at least one processor to transmit the query to all of the components that are communicatively coupled to the physical communications bus. The communications bus may be a Controller Area Network (“CAN”) Bus.

The communications network may be a wireless communications network, and may further include: at least one radio communicatively coupled to the at least one processor; and at least one antenna communicatively coupled to the at least one radio, and wherein the instructions, when executed by the at least one processor, may cause the at least one processor to transmit the query via the at least one radio and the at least one antenna. The at least one processor-readable medium may further store processor-executable instructions that when executed by the at least one processor cause the at least one processor to transmit a message containing a first node address corresponding to one of the number of components and a first instruction for the respective component corresponding to the first node address to perform. The at least one processor-readable medium may further store processor-executable instructions that when executed by the at least one processor cause the at least one processor to transmit the message containing the first node address, the first instruction, and an indication of priority for the message. The at least one processor-readable medium may further store processor-executable instructions that when executed by the at least one processor cause the at least one processor to transmit the message containing the first node address and an indication of priority for the message as an identifier, along with the first instruction. The at least one sensor may include at least one imager which has a field of vision, the field of vision which is oriented to capture images of at least one of the one or more of the spaces of the array of spaces and any of the components received in those spaces. At least one of the number of components may be an oven unit.

A method of operating a system with a plurality of components which are selectively positionable in respective spaces of an array of spaces may be summarized as including: monitoring via data received from at least one sensor one or more components positioned in the respective spaces of the array of spaces; detecting a detectable controllable action from one of the components; and in response to detecting the detectable controllable action from one of the components, storing a relationship between a physical location of the space in the array of spaces in which the respective component is positioned and a node address via which the respective component is addressed on a communications network, the communications network including one or more nodes that are communicatively coupleable to respective ones of the plurality of components.

The method of operating a system with a plurality of components which are selectively positionable in respective spaces of an array of spaces may further include causing the at least one processor to cause the component to perform the detectable controllable action.

The component may be caused to produce at least one of a manifestation, a signal, and an indication as the detectable controllable action. The component may be caused to at least one of activate or deactivate a light, produce an output of a display screen, generate an aural output, generate a tactile output, open or close a door, or change in temperature.

The method of operating a system with a plurality of components which are selectively positionable in respective spaces of an array of spaces may further include querying the components for the respective node addresses.

The node addresses may be randomly generated at the components, and the method of operating a system with a plurality of components which are selectively positionable in respective spaces of an array of spaces may further include checking for collisions between the randomly generated node addresses received from the components, and in response to detecting a collision between at least two of the received node addresses, causing a random generation of at least one new node address.

The node addresses may be randomly generated at the components, and the method of operating a system with a plurality of components which are selectively positionable in respective spaces of an array of spaces may further include checking for collisions between the randomly generated node addresses received from the components, and in response to detecting a collision between at least two of the received node addresses, causing a random generation of new node addresses for each of the components.

The method of operating a system with a plurality of components which are selectively positionable in respective spaces of an array of spaces may further include rebroadcasting the query to all nodes on the communications network in order to cause the random generation of at least one new node address.

Querying may further include broadcasting the query to all nodes on the communications network.

The method of operating a system with a plurality of components which are selectively positionable in respective spaces of an array of spaces may further include receiving the respective node addresses for the components from the components.

Querying may occur during an addressing mode of operation. The communications network may be a physical communications bus, and the querying may further include transmitting to all of the components that are communicatively coupled to the physical communications bus. The communications bus may be a Controller Area Network (“CAN”) Bus. The communications network may be a wireless communications network, and querying may further include transmitting to the components via at least one radio and at least one antenna.

The method of operating a system with a plurality of components which are selectively positionable in respective spaces of an array of spaces may further include transmitting a message containing a first node address corresponding to one of the number of components and a first instruction for the respective component corresponding to the first node address to perform.

The message containing the first node address and the first instruction may further include an indication of priority for the message. The first node address and an indication of priority for the message may be included in the message as an identifier. The at least one sensor may include at least one imager which has a field of vision, the field of vision which is oriented to capture images of at least one of the one or more of the spaces of the array of spaces and any of the components received in those spaces. At least one of the number of components may be an oven unit.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic diagram showing a control unit communicatively coupled to a plurality of components positioned within respective spaces in an array of spaces, according to at least one illustrated implementation.

FIG. 1B is a block diagram showing a control unit, an imager, and multiple components communicatively coupled to a communication bus, according to at least one illustrated implementation.

FIG. 2 is a flow diagram for receiving a request for, and assigning, a node address, according to at least one illustrated implementation.

FIG. 3 is a flow diagram for identifying location and other information related to a component that has been assigned a node address, according to at least one illustrated implementation.

FIG. 4 is a flow diagram for identifying location and other information related to each of a plurality of components that have been assigned node addresses, according to at least one illustrated implementation.

FIG. 5 is a flow diagram for a component to request and receive a node address, according to at least one illustrated implementation.

FIG. 6 is a flow diagram for resolving priority among messages that have collided when transmitted on a communications bus, according to at least one illustrated implementation.

FIG. 7 is a block diagram of a control unit used to associate node addresses with one or more of the components communicatively coupled to a communications bus, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, networks including packet switching networks or cellular networks and related infrastructure (e.g., base stations, home resource locator system, visitor resource locator system, SS7 systems) as well as networks and other communications channels have not been shown or described in detail to avoid unnecessarily obscuring descriptions of the embodiments.

In other instances, certain structures associated with food preparation devices such as ovens, skillets, and other similar devices, closed-loop controllers used to control cooking conditions, food preparation techniques, wired and wireless communications protocols, wired and wireless transceivers, radios, communications ports, geolocation, and optimized route mapping algorithms have not been shown or described in detail to avoid unnecessarily obscuring descriptions of the embodiments. In other instances, certain structures associated with conveyors, robots, and/or vehicles have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

As used herein the terms “food item” and “food product” refer to any item or product intended for human consumption. One of ordinary skill in the culinary arts and food preparation will readily appreciate the broad applicability of the systems, methods, and apparatuses described herein across any number of prepared food items or products, including cooked and uncooked food items or products, and ingredients or components of food items and products.

As used herein the terms “robot” or “robotic” refer to any device, system, or combination of systems and devices that includes at least one appendage, typically with an end of arm tool or end effector, where the at least one appendage is selectively moveable to perform work or an operation useful in the preparation a component, item, or product. The robot may be autonomously controlled, for instance based at least in part on information from one or more sensors (e.g., optical sensors used with machine-vision algorithms, position encoders, temperature sensors, moisture or humidity sensors). Alternatively, one or more robots can be remotely controlled by a human operator. Alternatively, one or more robots can be partially remotely controlled by a human operator and partially autonomously controlled.

As used herein the term “food preparation unit” or “food preparation component” refers to any device, system, or combination of systems and devices useful in preparing, cooking or heating a food product (e.g., cooking units), or cooling, refrigerating, freezing, or handling a food product. While such preparation may include the heating of food products during preparation, such preparation may also include the partial or complete cooking of one or more food products. Additionally, while the term “oven” may be used interchangeably with the term “cooking unit” herein, such usage should not limit the applicability of the systems and methods described herein to only foods which can be prepared in an oven. For example, one or more burners, either gas or electric or inductive, a hot skillet surface or griddle, a deep fryer, a microwave oven, rice cooker, sous vide cooker, and/or toaster can be considered a “cooking unit” that is included within the scope of the systems, methods, and apparatuses described herein. Food preparation units may include other types of components used to prepare food items, such as components related to cooled or chilled foods, such as may be used to prepare smoothies, frozen yogurt, ice cream, and beverages (e.g., fountain beverages). Further, the food preparation unit may be able to control more than temperature. For example, some food preparation units may control pressure and/or humidity. Further, some food preparation units may control airflow therein, thus able to operate in a convective cooking mode if desired, for instance to decrease cooking time.

As used herein the term “delivery vehicle” or “vehicle” refers to any car, truck, van, or other vehicle useful in delivering an item or product to a customer. As related to food delivery, the delivery vehicle or vehicle may be useful in cooking and heating a food item during a delivery process to a customer. The size and shape of the delivery vehicle may depend in part on licensing requirements of the locality in which the delivery vehicle is intended to operate. In some instances, the size and shape of the delivery vehicle may depend on the street layout and the surrounding environment of the locality in which the delivery vehicle is intended to operate. For example, small, tight city streets may require a delivery vehicle that is comparatively shorter and/or narrower than a delivery vehicle that can safely and conveniently navigate larger, suburban thoroughfares.

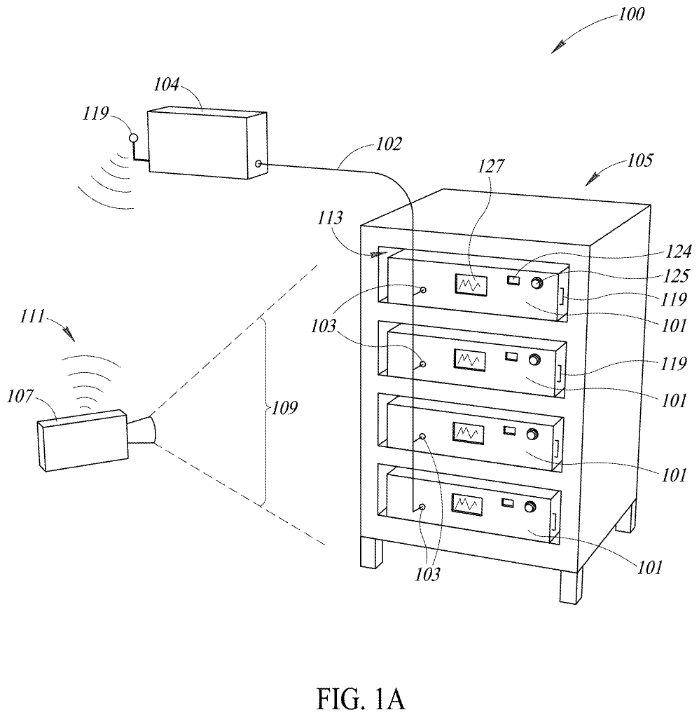

FIG. 1A shows a communications system 100 that includes a control unit 104 that is communicatively coupled to a plurality of components 101 positioned within respective spaces 113 in an array of spaces 105, according to at least one illustrated implementation. Although one control unit 104 is shown in FIG. 1A, the operation and function of the control unit 104 may be performed by a plurality of control units, including a plurality of distributed control units that are located remotely from each other and/or the components 101. The control unit 104 may be communicatively coupled to the components 101 via a communications bus 102. The components 101 may be any type of device that can receive instructions and communications via the communications bus 102 and provide a response to such instructions. For example, components 101 may include one or more types of servers, computers, routers, or other computing and/or networking devices, modular ovens, assembly line workstations, cooling devices (e.g., refrigerators or freezers), or any other type of electric and/or electronic device that may receive and respond to instructions. In some implementations, the array of spaces 105 may include, for example, a server rack, an oven rack, or any other such storage type of rack or cabinet that may include a plurality of spaces 105 that may be used to hold and/or store multiple components 101. In some implementations, the respective spaces 113 may include physical spaces occupied by a component or which can be occupied (i.e., occupiable) by a component. For example, the respective spaces 113 may include physical locations along an assembly line, physical locations in a vehicle, locations in a rack, shelving and/or in a warehouse or on the street. The location of those spaces can, for example, be determined a regional or global navigation system. In some implementations, the respective spaces 113 may be fixed, while in other implementations the respective spaces 113 may not be fixed, for example moving throughout a physical environment. In some implementations, a collection or set of respective spaces 113 may change, with new spaces becoming available or previously existing spaces removed or unavailable, and the total number of spaces 113 may vary over time.

The communications bus 102 may include one or more backplane buses, parallel cables, serial cables, or any other current or future developed tethered or wireless channels capable of communications, for instance via one or more transmission and/or interface standards Firewire®, IEEE 802.11, Thunderbolt®, or such. In some implementations, the communications bus 102 may be implemented using a Controller Area Network (“CAN”) bus, a Media Oriented Systems Transport (“MOST”) bus, a FlexRay standard, Society of Automotive Engineers standard SAE J1939, or other similar protocol or standard for communications bus that may be used to communicatively couple devices or components within a vehicle. In some implementations, the communications bus may be implemented, for example, using a short-range wireless communications protocol (e.g., Bluetooth®, Bluetooth® Low Energy, WIFI®, NFC) and/or long-range wireless communications protocols such as HF, VHF, etc. Such radio signals for the short-range and/or long-range wireless communications may be analog or digital. The communications bus may support broadcast communications, which may be used to distribute virtual addresses to components communicatively coupled to the communication bus. As discussed below, the physical location of such components may be identified, and the physical locations associated with the virtual address.

The communications bus 102 may include one or more nodes 103 that may be placed at a plurality of physical locations along the communications bus 102. Such physical locations may correspond, for example, to each of the spaces 113 in the array of spaces 105. In some implementations, the physical locations may be relative physical locations, such as, e.g., a physical location within the interior of a vehicle when the communications bus 102 is implemented in a vehicle. In some implementations, the physical location may be an absolute location, such as, e.g., latitude, longitude, and elevation values provided by a global and/or regional navigation systems (e.g., the Global Positioning System (GPS), GLONASS, Galileo, BeiDou Navigation Satellite System). As such, the nodes 103 may be associated with physical locations, such as, e.g., physical locations within the interior of a vehicle when the communications bus 102 is implemented in a vehicle. Each of the nodes 103 may be physically and/or communicatively coupled to respective ones of the components 101. Each component 101 that is communicatively coupled to a node 103 may have a node address that is distinct from any other component communicatively coupled to the communications bus 102. In some implementations, the node address may be comprised of a network address.

The control unit 104 may include any single or multi-cored controller or processor, including an application specific integrated circuit (ASIC); a reduced instruction set computer (RISC); a digital signal processor (DSP); a programmable logic controller (PLC); a microprocessor; or a microcontroller, for example. The multi-cored controller or processor may execute instructions stored in a memory component, as discussed below. In some implementations, the control unit 104 may store information related to the components 101 communicatively coupled to the communications bus 102. Such information may include, for example, type of component, physical location of component, and/or possible actions that a component may take.

In some implementations, the control unit 104 may issue instructions via the communications bus 102 to one or more of the components 101 to perform a detectable, controllable action. Such an action may include, for example, turning ON or turning OFF, activating a light source 124, displaying a message on a changeable display 127, vibrating (using, for example, an off-balance motor), producing an aural sound via a sound source 125, producing a tactile output, and/or activating a heat source (for example, in the case of an oven unit). In some implementations, the control unit 104 may communicatively couple, and thereby issue instructions, to the components 101 via a wireless network 111. In such an implementation, each of the control unit 104 and the components 101 may include a radio 119 that may be used to transmit and/or receive messages transmitted on the wireless network 111.

The control unit 104 may be communicatively coupled to a sensor 107 that is positioned to monitor one or more of the components 101 and is capable of detecting the detectable controllable actions performed by each of the components 101 being monitored. As shown in FIG. 1A, for example, the sensor 107 may include an imager that has a field of vision 109 that encompasses one or more of the spaces 113 in the array of space 105, as well as any components 101 occupying any of such spaces 113. In other implementations, the sensor 107 may be capable of detecting temperature, movement, and/or sound, depending upon the type of detectable controllable actions that the components 101 being monitored may perform. The sensor 107 in some implementations may be communicatively coupled to the control unit 104 via the wireless network 111. In some implementations, the sensor 107 may be communicatively coupled to the control unit 104 via the communications bus 102 (not shown). The sensor 107 may transmit information to the control unit 104 when it detects a detectable controllable action being performed by one or more of the components 101. The control unit 104 may use this information to identify and store a relationship between the physical and/or relative location of the activated component 101 and the node address of the activated component 101. In some implementations, the control unit 104 may be communicatively coupled to multiple sensors 107 that provide non-overlapping and/or partially overlapping fields of vision 109. In such an implementation, the control unit 104 may store relationships between the physical and/or relative positions of some or all of the components 101 being monitored by the multiple sensors 107 and the physical locations of such components. In some implementations, the control unit 104 that issues the instructions to the components 101 may be different from the control unit 104 that identifies and stores the relationship between the node address and the physical locations of each of the components 101.

FIG. 1B shows the communications system 100 in which the communications bus 102 is used to communicatively couple the control unit 104, a number of components (e.g., a first oven rack 106, a configurable rack 108 (e.g., a server rack), a first workstation 110, and a first food preparation unit 112), an imager 114, and a sound capturing component (e.g., microphone 115). The communications bus 102 may include one or more backplane buses, parallel cables, serial cables, or any other current or future developed tethered or wireless channels capable of communications, for instance via one or more transmission and/or interface standards Firewire®, IEEE 802.11, Thunderbolt®, or such. In some implementations, the communications bus 102 may be implemented using a Controller Area Network (“CAN”) bus, a Media Oriented Systems Transport (“MOST”) bus, a FlexRay standard, Society of Automotive Engineers standard SAE J1939, or other similar protocol or standard for communications bus that may be used to communicatively couple devices or components within a vehicle. In some implementations, the communications bus may be implemented, for example, using a short-range wireless communications protocol (e.g., Bluetooth®, Bluetooth® Low Energy, WIFI®, NFC). The communications bus 102 may include one or more nodes 103 that may be placed at a plurality of physical locations along the communications bus 102. As such, the nodes 103 may be associated with physical locations, such as, e.g., physical locations within the interior of a vehicle when the communications bus 102 is implemented in a vehicle. The nodes 103 may be used to physically and/or communicatively couple together components (such as, for example, one or more of the control unit 104, the first oven rack 106, the configurable rack 108, the first workstation 110, and the first food preparation unit 112, the imager 114, and the microphone 115) within the communications system 100.

In some implementations, components communicatively coupled to one of the nodes 103 may be assigned a node address. Such a node address, as discussed below, may be used to communicate messages along the communications bus 102 to be received by specific components. As such, each component communicatively coupled to the communications bus 102 may be assigned a non-overlapping value for a node address, such that the node address assigned to each component is unique for the communications bus 102. As such, the node address may serve as a communications address to enable components to communicate via the communications bus 102.

The control unit 104 may include any single or multi-cored controller or processor, including an application specific integrated circuit (ASIC); a reduced instruction set computer (RISC); a digital signal processor (DSP); a programmable logic controller (PLC); a microprocessor; or a microcontroller, for example. The multi-cored controller or processor may execute instructions stored in a memory component, as discussed below. In some implementations, the control unit 104 may include or be communicatively coupled to a database 126 that may be used to store information related to the various components communicatively coupled to the communications system 100. Such information may include, for example, type of component, physical location of component, and/or possible actions that a component may take. Although shown as a single component in FIG. 1B, the database 126 may be stored within the memory of the control unit 104 or may be distributed among multiple memory storage units (e.g., servers).

The control unit 104 may be communicatively coupled to a node 103 placed along the communications bus 102, thereby enabling the control unit 104 to communicate with other components also communicatively coupled to the communications bus 102. In some implementations, the control unit 104 may assign node addresses to the various components communicatively coupled to the communications bus 102. In such an implementation, the control unit 104 may include capabilities such as those provided, for example, by a domain host configuration protocol (DHCP) server. In some implementations, as discussed below, the control unit 104 may include a first node address, which may be used to transmit data and messages from and to the control unit 104. As such, the node address may serve as a communications address to enable the control unit 104 to communicate on the communications bus 102. In some implementations, the node address associated with the control unit 104 may signify that messages from the control unit 104 have priority over messages from other components on the communications bus 102.

The first oven rack 106 may include a plurality of first oven units 116a-116i (collectively, “first oven units 116”). The first oven rack 106 may be communicatively coupled to a node 103 placed along the communications bus 102, thereby enabling the first oven rack 106 to communicate with other components also communicatively coupled to the communications bus 102. In some implementations, as discussed below, the first oven rack 106 may include a first node address, which may be used to transmit data and messages from and to the first oven rack 106.

In some implementations, each of the first oven units 116 may be individually programmable to prepare and cook food items. In such an implementation, each of the first oven units 116 may have a separate address, such that each oven unit 116 may be addressed by and receive instructions from the control unit 104. In some implementations, a plurality of first oven units 116 may be controlled as a unit or set to prepare and cook food items. In such an implementation, each unit or group of first oven units 116 may have a separate address, such that each unit or group of first oven units 116 may receive communications and instructions from the control unit 104. In some implementations, the first oven units 116 may be communicatively coupled to the communications bus 102 via a first local bus 128.

Each of the first oven units 116 may include a housing disposed at least partially about an interior of an oven compartment formed by one or more surfaces. The interior of the oven compartment may be accessed via an oven door 117 (one referenced in FIG. 1B). Food items are cooked under defined cooking conditions within the interior of the first oven units 116. A hinged or otherwise displaceable door may be used to isolate the interior of the first oven units 116 from the external environment. In at least some instances, the door may be mechanically or electro-mechanically held closed while the cooking process is underway. The first oven units 116 may include one or more heat sources or heat elements that are used to provide heat to the interior cavity. In addition to the heating element, additional elements such as convection fan(s), humidifiers, gas burners, or similar items (not shown for clarity) may be installed in place of or along with the heating element in the first oven units 116.

In some implementations, one or more of the oven units may have a light source 124 (one identified within first oven rack 106) that may be used to determine a state or condition within each associated first oven unit 116. For example, in some implementations, the light source 124 may indicated that the associated first oven unit 116 is in an ON state in which the heat source or heat elements are heating the interior compartment of the associated first oven units 116. In some implementations, the color of the light source 124 may vary depending upon one or more factors or conditions associated with the first oven unit 116 (e.g., the temperature within the interior cavity, whether the associated first oven unit 116 is heating or at a desired temperature). In some implementations, the light source 124 may be selectively activated, for example, as a result of instructions received from the control unit 104 via the communications bus 102. Such activation may result in a constant light being emitted from the light source, or a light that is emitted with a pattern (e.g., a flashing or strobing light, or a light that changes colors according to a pattern). In some implementations, the first oven unit 116 may include one or more changeable displays 127 (one shown in FIG. 1B) that may be used to display information related to the operation of the first oven unit 116 and/or information related to instructions received via the communications bus 102. In some implementations, at least some of the first oven units 116 may include a sound source 125 that may be selectively activated, for example, as a result of instructions received from the control unit 104 via the communications bus 102. Such activation may result in a constant tone being emitted from the sound source 125, or a sound that is emitted with a pattern (e.g., a beeping sound). In some implementations, the oven door 117 associated with a first oven unit 116 may be selectively opened and/or closed based upon instructions received from the control unit 104 via the communications bus 102. In some implementations, the heating unit within a first oven unit 116 may be selectively activated and/or deactivated based upon instructions received from the control unit 104 via the communications bus 102.

The configurable rack 108 may include a plurality of server and/or server components 118a-118i (collectively, “server and/or server components 118”). The configurable rack 108 may be communicatively coupled to a node 103 placed along the communications bus 102, thereby enabling the configurable rack 108 to communicate with other components also communicatively coupled to the communications bus 102. In some implementations, as discussed below, the configurable rack 108 may include a first node address, which may be used to transmit data and messages from and to the configurable rack 108.

In some implementations, each of the server and/or server components 118 may be individually programmable to prepare and cook food items. In such an implementation, each of the server and/or server components 118 may have a separate address, such that each server and/or server components 118 may be addressed by and receive instructions from the control unit 104. In some implementations, a plurality of server and/or server components 118 may be controlled as a unit or set to prepare and cook food items. In such an implementation, each unit or group of server and/or server components 118 may have a separate address, such that each unit or group of server and/or server components 118 may receive communications and instructions from the control unit 104. In some implementations, the server and/or server components 118 may be communicatively coupled to the communications bus 102 via a second local bus 130.

In some implementations, one or more of the server and/or server components 118 may have a light source 124 (one identified within configurable rack 108) that may be used to determine a state or condition within each associated server and/or server components 118. For example, in some implementations, the light source 124 may indicated that the associated server and/or server component 118 is in an ON state. In some implementations, the color of the light source 124 may vary depending upon one or more factors or conditions (e.g., various error conditions) associated with the server and/or server components 118. In some implementations, the light source 124 may be selectively activated, for example, as a result of instructions received from the control unit 104 via the communications bus 102. Such activation may result in a constant light being emitted from the light source, or a light that is emitted with a pattern (e.g., a flashing or strobing light, or a light that changes colors according to a pattern). In some implementations, the server and/or server components 118 may include one or more changeable displays 127 (one shown in FIG. 1B) that may be used to display information related to the operation of the server and/or server components 118 and/or information related to instructions received via the communications bus 102. In some implementations, at least some of the server and/or server components 118 may include a sound source 125 that may be selectively activated, for example, as a result of instructions received from the control unit 104 via the communications bus 102. Such activation may result in a constant tone being emitted from the sound source 125, or a sound that is emitted with a pattern (e.g., a beeping sound).

The first workstation 110 may include devices or components at which items or products are assembled. Each workstation 110 may include one or more robots 120 that are operable to assemble items or products on demand (i.e. in response to actually received orders or self-generated orders). The robots 120 may each be associated with one or more workstations 110, for instance one robot per workstation. In some implementations, one or more workstation 110 may not have an associated robot 120, and may have some other piece of associated equipment and/or even a human present to perform certain operations. The first workstation 110 may be communicatively coupled to a node 103 placed along the communications bus 102, thereby enabling the first workstation 110 to communicate with other components also communicatively coupled to the first workstation 110. In some implementations, as discussed below, the first workstation 110 may include a first node address, which may be used to transmit data and messages from and to the first workstation 110.

In some implementations, the first workstation 110 may include a light source 124 that may be selectively activated, for example, as a result of instructions received from the control unit 104 via the communications bus 102. Such activation may result in a constant light being emitted from the light source 124, or a light that is emitted with a pattern (e.g., a flashing or strobing light, or a light that changes colors according to a pattern). In some implementations, the first workstation 110 may include one or more changeable displays 127 that may be used to display information related to the operation of the first workstation 110 and/or information related to instructions received via the communications bus 102. In some implementations, the first workstation 110 may include a sound source 125 that may be selectively activated, for example, as a result of instructions received from the control unit 104 via the communications bus 102. Such activation may result in a constant tone being emitted from the sound source 125, or a sound that is emitted with a pattern (e.g., a beeping sound).

The first food preparation unit 112 may include one or more devices, systems, or combinations of systems and devices useful in preparing, cooking or heating a food product, such as, for example, cooking units. While such preparation may include the heating of food products during preparation, such preparation may also include the partial or complete cooking of one or more food products. The cooking unit may include one or more of burners, either gas or electric or inductive, hot skillet surfaces or griddles, deep fryers, microwave ovens, rice cookers, sous vide cookers, ovens, and/or toasters. The first food preparation unit 112 may include other types of components used to prepare food items, such as components related to cooled or chilled foods, such as may be used to prepare smoothies, frozen yogurt, ice cream, and beverages (e.g., fountain beverages). The first food preparation unit 112 may be communicatively coupled to a node 103 placed along the communications bus 102, thereby enabling the first food preparation unit 112 to communicate with other components also communicatively coupled to the first food preparation unit 112. In some implementations, as discussed below, the first food preparation unit 112 may include a first node address, which may be used to transmit data and messages from and to the first food preparation unit 112.

In some implementations, the first food preparation unit 112 may include a light source 124 that may be selectively activated, for example, as a result of instructions received from the control unit 104 via the communications bus 102. Such activation may result in a constant light being emitted from the light source, or a light that is emitted with a pattern (e.g., a flashing or strobing light, or a light that changes colors according to a pattern). In some implementations, the first food preparation unit 112 may include a sound source 125 that may be selectively activated, for example, as a result of instructions received from the control unit 104 via the communications bus 102. Such activation may result in a constant tone being emitted from the sound source 125, or a sound that is emitted with a pattern (e.g., a beeping sound). In some implementations, the first food preparation unit 112 may include a changeable display 127, such as, for example, an LCD screen. Such a changeable display 127 may be used to display information regarding the present and/or past operating conditions of the first food preparation unit 112. Such a changeable display 127 may be used to display information related to one or more commands, instructions, or messages received via the communications bus 102.

The imager 114 may be used to capture images of products or components within a field-of-view of the imager 114. In some implementations, the imager 114 may be oriented such that the field-of-view captures one or more of the components communicatively coupled to the communications bus 102 (e.g., first oven rack 106, first oven units 116, configurable rack 108, server and/or server components 118, first workstation 110, and/or first food preparation unit 112). In some implementations, the imager 114 may be rotatable and/or movable to change the area captured by the field-of-view. Although FIG. 1B shows one imager 114, in some implementations, multiple imagers 114 may be used to capture varying images of the components communicatively coupled as part of the communications system 100. The imager 114 may include one or more photosensor arrays, such as, for example, an array of charge-coupled devices or CCDs, used to capture digital photo or video data. In some implementations, the imager 114 may be a thermal imager that may be able to detect relative and/or absolute temperatures of various devices. The imager 114 may further include may include one or more lenses that may be used to provide an optical path to capture light for photographic and/or video images. The imager 114 may be communicatively coupled to a node 103 placed along the communications bus 102, thereby enabling the imager 114 to communicate with other components also communicatively coupled to the communications bus 102. In some implementations, as discussed below, the imager 114 may include a first node address, which may be used to transmit data and messages from and to the imager 114.

The microphone 115 or other sound capturing component may be used to capture sounds of products or components. In some implementations, the microphone 115 may be oriented such as to capture sounds from one or more of the components communicatively coupled to the communications bus 102 (e.g., first oven rack 106, first oven units 116, configurable rack 108, server and/or server components 118, first workstation 110, and/or first food preparation unit 112). In some implementations, the microphone 115 may be rotatable and/or movable to change the direction and/or area from which sound may be captures. Although FIG. 1B shows one microphone 115, in some implementations, multiple microphones 115 may be used to capture varying sounds of the components communicatively coupled as part of the communications system 100. The microphone 115 may include one or more transducers used to capture digital sound data. The microphone 115 may be communicatively coupled to a node 103 placed along the communications bus 102, thereby enabling the microphone 115 to communicate with other components also communicatively coupled to the communications bus 102. In some implementations, as discussed below, the microphone 115 may include a first node address, which may be used to transmit data and messages from and to the microphone 115.

In some implementations, the communications system 100 may include a second communications medium, such as, for example, the wireless network 122. In such an implementation, for example, the control unit 104 and at least some of the other components on the communication system 100 may be communicatively coupled to a wireless network 122, which may be implemented, using a short-range wireless communications protocol (e.g., Bluetooth®, Bluetooth® Low Energy, WIFI®, NFC). In some implementations, for example, the wireless network 122 may be used to provision node addresses on the communications bus 102 to the components on the communications system 100. In such an implementation, the communications bus 102 may be used to transmit and receive data communications, and the wireless network 122 may be used to transmit and receive communications to provision network resources (e.g., request and assign node addresses for use on the communications bus).

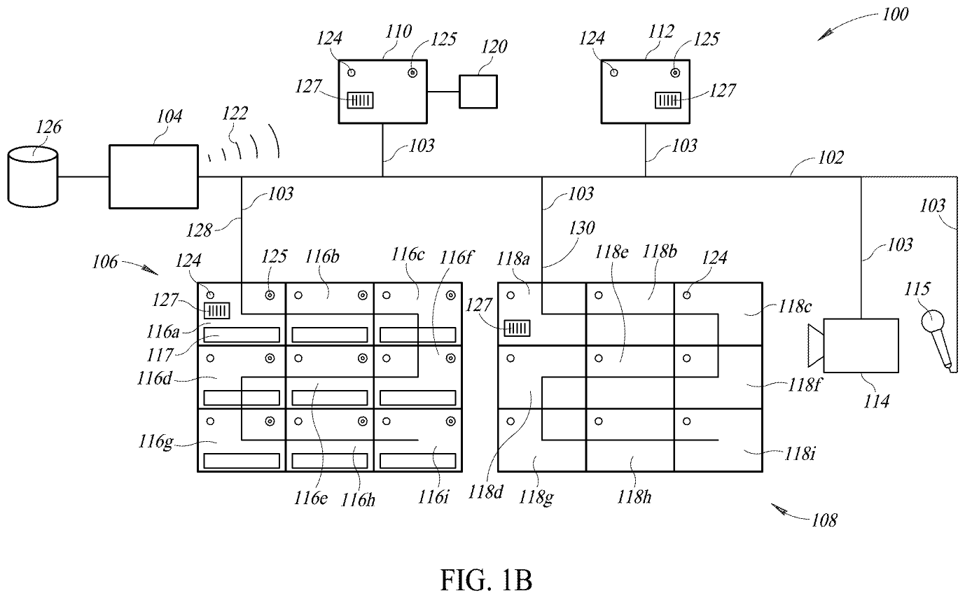

FIG. 2 shows a method 200 for receiving a request for, and confirming, a node address to a component (e.g., first oven rack 106 and/or configurable rack 108) communicatively coupled to the communication bus 102, according to at least one illustrated implementation. At 202, a request is received from one of the components (e.g., first oven rack 106, configurable rack 108, first workstation 110, and/or first food preparation unit 112) for a node address. In some implementations, the request for a node address may be received from individual components 101 that are communicatively coupled to the communications bus 102 and/or wireless network 122.

In some implementations, the request for a node address received from the component 101 may include a value for the node address to be assigned. In such an implementation, the component 101 may randomly generate the value for the node address from a large number space of possible values, such that the space of possible values for the requested node address is substantially larger than the number of components 101 that may be communicatively coupled to the communications bus 102. As such, the large space of possible values may reduce the possibility that components may request the same node address, thereby causing a collision between node addresses. The method 200 proceeds to 204.

At 204, the requested value for the node address is reviewed to determine if the requested value is appropriate and acceptable. Such a check of the node address may be performed by the control unit 104. For example, in some implementations, the control unit 104 may determine if the same value requested for the node address has already been assigned to, and thereby collides with, another component on the communications bus 102. In some implementations, the check for collisions may further determine if the requested value for the node address is within an appropriate range. For example, in some implementations, the value of the node address may be used to determine the priority of communications and packets on the communications bus 102. Thus, the node address with the higher (or lower) numerical value may have priority on the communications bus 102 when multiple components transmit on the communications bus 102 at the same time. In such an implementation, the control unit 104 may have multiple ranges or levels of numerical values for node addresses, in which each range or level corresponds to a level of priority. As such, components that transmit critical, time sensitive packets or communications (e.g., the control unit 104) may have a numerical value for the node address drawn from a node address range or level that indicates such priority. A process for resolving contention caused by simultaneously having multiple packets or communications on the communication bus 102 is discussed below. If the requested value for a node address is appropriate, the method 200 progresses to 206. If the requested value for a node address is not appropriate, the method 200 progresses to 208.

At 206, a message is optionally transmitted confirming the requested value for the node address. The message may be transmitted from the control unit 104 via the wireless network 122 and/or the communications bus 102 in some implementations. The control unit 104 may additionally update the database 126 with an entry noting that the assigned node address is no longer available. The database entry may include additional data fields, such as type of component, physical location of component, and/or possible actions for the component, that may be used to store additional information regarding the component associated with the stored node address. In some implementations, the additional information may need to be determined by the communications system 100, as discussed below. In some implementations, the control unit 104 may not transmit any confirmation message if the requested node address is allowable. In such an implementation, the requesting component 101 may consider the requested node address to be appropriate unless it receives a rejection notification.

At 208, a message is transmitted rejecting the requested value for the node address. The message may be transmitted from the control unit 104 via the wireless network 122 and/or the communications bus 102 in some implementations. In some implementations, the control unit 104 may transmit only the rejection message to the requesting component at which point the requesting component 101 may submit another request for a node address, having a different value, to the control unit 104. In some situations, the control unit 104 may transmit an alternative node address to the requesting component as part of the rejection message. As such, the alternative node address may denote the same level of priority (e.g., be drawn from the same priority level or range) as the requested node address. In some implementations, the control unit 104 may assign the alternative node address to the requesting component with no further communication. In some implementations, the control unit 104 may not assign the alternative node address to the requesting component until receiving a confirmation from the requesting component for the alternative node address.

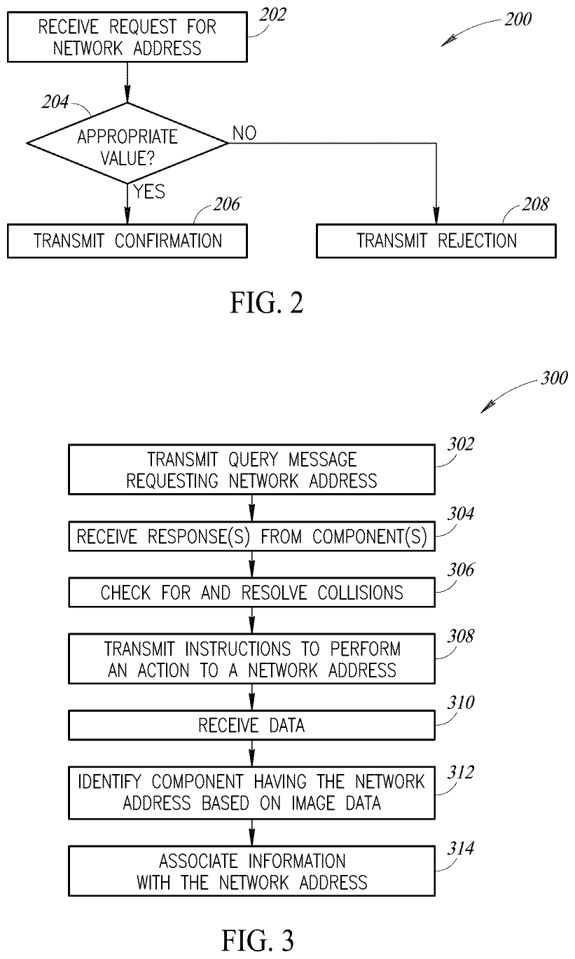

FIG. 3 shows a method 300 for identifying physical location and other information related to a component communicatively coupled to a communications bus (e.g., the first oven rack 106 and/or the configurable rack 108) that has previously been assigned a node address, according to at least one illustrated implementation. At 302, the control unit 104 transmits a query to the other components 101 within the communications system 100 requesting that each component 101 respond with a message indicating the assigned node address. In some implementations, such a query may be broadcast via the communications bus 102 and/or the wireless network 122. The method 300 then proceeds to 304.

At 304, the control unit 104 receives a response from each component 101 communicatively coupled to the communications bus 102. The response may be received by the control unit 104 via the communications bus 102 and/or the wireless network 122. In some implementations, one or more of the components 101 may generate a new random node address in response to receiving the query at 302 and transmit the newly generated, random node address at 304. As such, the query broadcast at 302 may serve to reset the node addresses for the components 101 on the communications bus 102. In some implementations, one or more of the components 101 may transmit a previously generated node address in response to receiving the query at 302. The control unit 104 may store each of the received node addresses as part of an entry in the database 126 implemented in a computer memory, such as a server. In some implementations, the control unit 104 may update each entry in the database 126 for each node address for which a response was received at 304. Such information may be used, for example, to maintain a keep-alive timer for the component 101 associated with the node address to prevent the node address from being assigned to another component 101 while the keep-alive timer is active. In some implementations, a keep-alive timer may be used to keep the entries within the database 126 current, as well as to delete any records associated with node addresses for components 101 that are no longer communicatively coupled to the communications system 100. The method 300 then proceeds to 306.

At 306, the control unit 104 checks for and resolves any collisions between the node addresses received at 304. In some implementations, such node addresses may be generated randomly by each of the respective components 101. In such an implementation, the components may generate the random node addresses from a very large number space to reduce the possibility of a collision. When a collision occurs, the control unit 104 may transmit a message to one or more of the components 101 with conflicting node addresses to cause one or more of such components 101 to generate new node addresses. In some implementations, the control unit 104 may broadcast a message that causes each of the components 101 communicatively coupled to the communications bus 102 to generate a new random node address. In some implementations, 302 through 306 may comprise an addressing mode of operation for the control unit 104. Once no more collisions exist between node addresses, the method 300 proceeds to 308.

At 308, instructions are transmitted in a message or packet to the node address associated with one of the components 101. Such instructions may be transmitted by the control unit 104 via the communications bus 102 and/or wireless network 122. The transmitted instructions may indicate that the component 101 associated with the node address perform a detectable controllable action, such as, for example, activating a light source (such as the light source 124), turning the component ON and/or turning the component OFF, moving an appendage, opening a door or tray, or some other such action, or making a sound. Such instructions may be included within a message or packet that includes the node address of the component 101 that is to perform the specified detectable controllable action. In some implementations, such a message or packet may also include a priority identifier for the message. In some implementations, the indication of priority may be included as part of the node address for one or both of the transmitting control unit 104 and/or the component 101 that is the intended recipient. The method 300 then proceeds to 310.

At 310, data may be received. Such data may be related, for example, to images (visual, thermal, etc.), sound, movement, electric and/or magnetic properties, thermal properties, or any other such data that may be produced by any type of detectable controllable action by the component 101. Image data, for example, may be transmitted from the imager 114 to the control unit 104 via the communications bus 102 and/or wireless network 122. The image data may comprise one or more of photographic and video data that captures images of one or more of the components communicatively coupled to the communications system 100. Such image data may correspond to visual, thermal or other types of images captured at and around the same time that the component 101 associated with the node address performed one or more actions pursuant to the instructions transmitted at 308. Sound data, for example, may be received by the microphone 115 or other sound capturing device(s) and transmitted to the control unit 104 via the communications bus 102 and/or wireless network 122. The sound data may comprise one or more sound data that captures sounds emitted by one or more of the components 101 communicatively coupled to the communications system 100. Such sound data may correspond to sounds that were captured at and/or around the same time that the component 101 associated with the node address performed one or more actions pursuant to the instructions transmitted at 308. The method 300 then proceeds to 312.

At 312, the control unit 104 reviews the data to identify the component 101 on the communications system 100 that performed one or more actions pursuant to the instructions transmitted at 308. As such, the control unit 104 may compare the instructed action that was transmitted as part of 308 with the data received at 310. If the control unit 104 determines that a match exists, the control unit 104 may then correlate the appropriate image data with the node address that was used to transmit the instructions at 308. In some implementations, the control unit 104 may identify the physical location of the component 101 that is identified. The method 300 then proceeds to 314.

At 314, the node address is associated with information related to the identified component 101. In some implementations, such association may be performed by the control unit 104. Such associated information about the identified component may be obtained from various sources, collected, and stored. Such information may be obtained, for example, from the images correlated at 312 with the node address. Such images may be used, for example, to determine and/or confirm the type of component that is coupled to the communications system 100. In addition, information about the identified component may be determined from the imager 114 that captured the associated image data from 312 and/or microphone 115 that captured the associated sound data from 312. For example, information regarding the physical location of the identified component may be related to, and determined from, the position and field-of-view of the imager 114 and/or from directional routines that use sound data captured by the microphone 115. The control unit 104 may collect and store a relationship between such information related to the identified component 101 and the node address for the identified component 101, using, for example, one or more appropriate entries in the database 126. Additional information may be identified and stored at 314, including, for example, information related to the physical location at which the identified component 101 is located. In some implementations, 308 through 314 may comprise an identification mode of operation for the control unit 104.

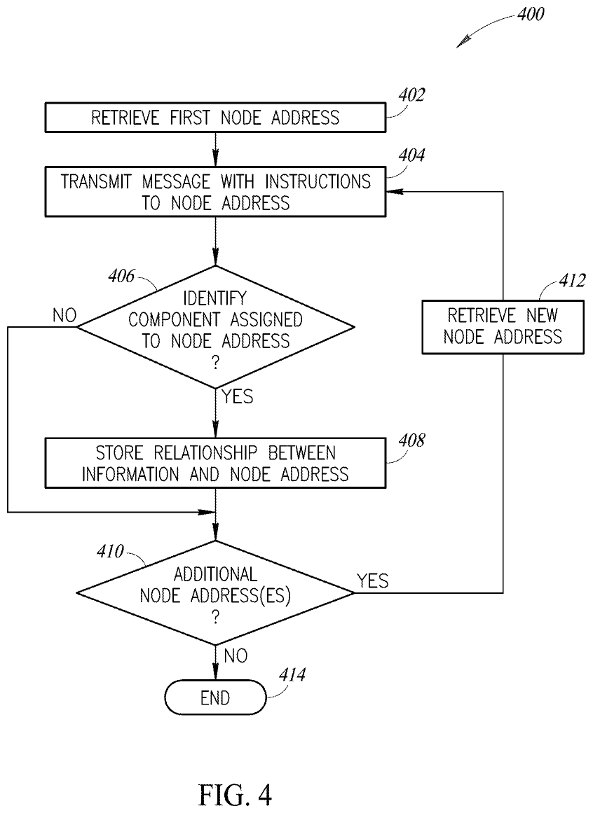

FIG. 4 shows a method 400 for identifying physical location and other information related to each of a plurality of components that have been assigned node addresses, according to at least one illustrated implementation. At 402, a first node address is retrieved. In some implementations, the control unit 104 may retrieve the first node address from the database 126 where the first node address had previously been stored, such as, for example, as part of method 200. The method 400 then proceeds to 404.

At 404, a message is transmitted with the node address retrieved at 402. Such a broadcast may be transmitted, for example, by the control unit 104 via the communications bus 102 and/or the wireless network 122. The broadcast message may include a value for a node address related to a component 101 that is to be identified. Such identification may be used, for example, to determine the physical location or other information related to the component 101. The value for the node address may be retrieved, for example, from the database 126 that the control unit 104 may maintain for each node address assigned to the communications system 100. The transmitted message may further include a detectable controllable action for the component 101 to perform. Such instructions may indicate that the component associated with the node address perform an action, such as, for example, activating a light source (such as the light source 124), turning the component ON and/or turning the component OFF, moving an appendage, opening a door, activating a heat source, displaying a message on a controllable display 127, providing a tactile response, or some other such action. The method 400 then proceeds to 406.

At 406, the component responding to the broadcast node address is identified. Such identification may be performed, for example, using some or all of method 300. The control unit 104 may receive data that may be transmitted from the sensor 107 via the communications bus 102 and/or wireless network 122. The data may comprise one or more of photographic, sound, video, or other type of data that captures information related to one or more of the components 101 communicatively coupled to the communications system 100. Such data, for example, may correspond to images that were captured at and around the same time that the component associated with the node address performed one or more actions pursuant to the transmitted instructions. Such data, for example, may correspond to sound data that may be transmitted from the microphone 115 via the communications bus 102 and/or wireless network 122. The sound data may be captured from one or more of the components communicatively coupled to the communications system 100. Such sound data may correspond to sounds that were captured at and around the same time that the component associated with the node address performed one or more actions pursuant to the transmitted instructions.

The control unit 104 may review the image, sound, and/or other data to identify the component on the communications system 100 that performed one or more actions pursuant to the transmitted instructions. As such, the control unit 104 may compare the instructed action that was transmitted as part of 306 with the data received at 308. Using filtering techniques and/or other types of logic, the control unit 104 may match an action captured by the data with the instructed action. If the control unit 104 determines that a match exists, the method 400 transitions to 408 in which the control unit 104 may then identify and store a relationship between information and data received at 406 with the node address to which the instructions were transmitted. Such information may include, for example, information regarding the physical location of the component 101. If no component 101 is identified, the method 400 transitions to 410 to determine if additional node addresses are stored in the database 126.

At 408, the node address is associated with information related to the identified component 101. In some implementations, such an association may be performed by the control unit 104 and result in a relationship between the identified information and the node address being stored. Information about the identified component may be collected, for example, from the images correlated as part of 408 with the node address. Such images may be used, for example, to determine and/or confirm the type of component that is coupled to the communications system 100. In addition, information about the identified component may be determined from the imager 114 that may have captured the associated image data and/or from the microphone 115 that may have captured the associated sound data. For example, information regarding the physical location of the identified component may be related to, and determined from, the position and field-of-view of the imager 114 and/or from directional logic associated with the microphone 115. The control unit 104 may collect and store such information related to the identified component in one or more appropriate entries in the database 126. The method 400 then proceeds to 410.

At 410, the control unit 104 determines if additional node addresses are stored, for example, in the database 126. Such node addresses may have been stored by the control unit 104 in the database 126, for example, as part of method 200. If no additional node addresses are stored in the database 126, the method 400 transitions to 414 where the method ends. If additional node addresses are stored in the database 126, the method 400 transitions to 412.

At 412, an additional node address is retrieved. In some implementations, the additional node addresses may be stored within the database 126 and retrieved by the control unit 104. The method 400 may then proceed to 404 to transmit a message with the additional node address.

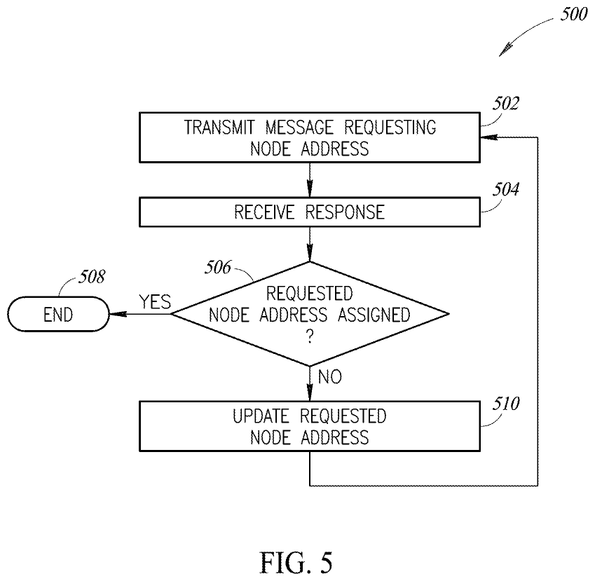

FIG. 5 shows a method 500 for requesting and receiving a node address, according to at least one illustrated implementation. Such a method 500 may be performed, for example, by a component communicatively coupled to the communication system 100. At 502, a message is transmitted requesting a node address. Such a request may be transmitted to the control unit 104 via the communications bus 102 and/or wireless network 122 by one of the components, e.g., first oven rack 106, first oven units 116, configurable rack 108, server and/or server components 118, first workstation 110, and/or first food preparation unit 112. In some implementations, the message may include a request for a specific value for the node address. In some implementations, the component 101 may randomly generate such requested values from large number spaces. Such large number spaces may reduce the possibility that the requested address will collide with an already existing node address for another component 101. Such a requested value for the node address may be selected from one of a plurality ranges or levels of numerical values for node addresses, in which each range or level corresponds to a level of priority. The method 500 then proceeds to 504.

At 504, a response is received to the request transmitted at 502. The response may be received from the control unit 104 via the communications bus 102 and/or wireless network 122 by the component that transmitted the request in 502. The method 500 then proceeds to 506.

At 506, the component determines if a node address has been assigned with the response received in 504. If a node address is assigned, the method 500 proceeds to 508 where the method 500 ends. If no node address is assigned, the method 500 proceeds to 510.

At 510, the component that transmitted the request at 502 may update the value of a node address to be requested. The control unit 104 may have multiple ranges or levels of numerical values for node addresses, in which each range or level corresponds to a level of priority. Such a requested value for the node address may be selected from one of a plurality ranges or levels of numerical values for node addresses, in which each range or level corresponds to a level of priority. The method 500 may then proceed to 502.

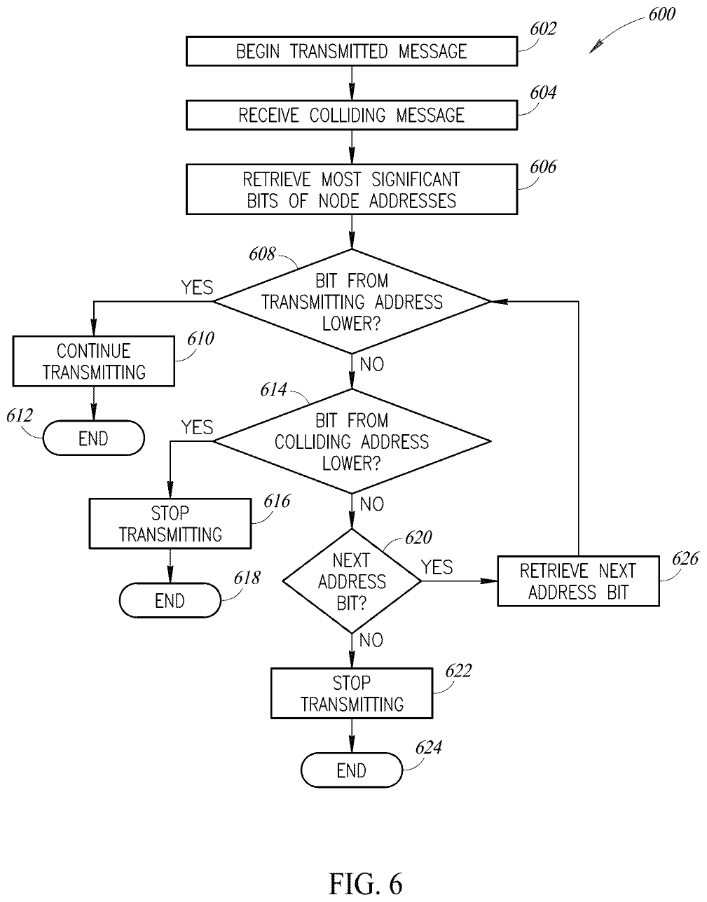

FIG. 6 shows a method 600 for resolving priority among messages that have collided when transmitted on the communications bus 102, according to at least one illustrated implementation. In the method 600, the component with the lowest value for the node address has priority. In some implementations, priority may be based on some other criteria (e.g., highest value has priority). At 602, one of the components and/or the control unit 104 may begin transmitting a message on the communications bus 102.

At 604, the transmitting component from 602 detects that another device or component has begun transmitting a message on the communications bus 102 at or about the same time. The transmitted message sent by the transmitting component collides (hereinafter, “the transmitted message”), and comes into contention, with the message transmitted by the other component (hereinafter, “the colliding message”). The transmitting component from 602 then proceeds to 606 to resolve the contention.

At 606, the transmitting component from 602 begins a bitwise comparison of the node addresses for the component sending the transmitted message and the component sending the colliding message. As such, the transmitting component from 602 retrieves the most significant bit in the node address for itself (i.e., the transmitting component) and the most significant bit in the node address for the other component that transmitted the colliding message. In some implementations, the node address associated with the component sending the colliding message may be contained within a data or overhead field that forms part of the colliding message. In such a situation, the node address associated with the component sending the colliding message may be detected and retrieved as the colliding message is received. The method 600 then proceeds to 608.

At 608, the transmitting component from 602 compares corresponding bits from the two different node addresses retrieved at 606 to determine if the bit associated with the transmitted message is lower. If the bit from the node address associated with the transmitted message from 602 is lower than the corresponding bit from the node address associated with the colliding message, the method 600 proceeds to 610. If the bit from the node address associated with the transmitted message from 602 is not lower than (i.e., is equal to or greater than) the corresponding bit from the node address associated with the colliding message, the method 600 proceeds to 614.

At 610, the transmitting component from 602 continues transmitting on the communications bus 102 because the contention protocol provides priority for the device or component with the lowest numerical value for the node address. In this situation, the node address for the transmitting component has the lowest numerical value, and therefor has priority over the component associated with the colliding message. The method 600 then ends at 612.

At 614, the transmitting component from 602 compares the corresponding bits from the two different node addresses retrieved at 606 to determine if the bit associated with the colliding message is lower. If the bit from the node address associated with the colliding message is lower than the corresponding bit from the node address associated with the transmitted message, the method 600 proceeds to 616. If the bit from the node address associated with the colliding message is not lower than (i.e., is equal to or greater than) the corresponding bit from the node address associated with the transmitted message, the method 600 proceeds to 620.

At 616, the transmitting component from 602 stops transmitting on the communications bus 102 because the contention protocol provides priority for the device or component with the lowest numerical value for the node address. In this situation, the node address for the component associated with the colliding message has the lowest numerical value, and therefor has priority over the component associated with the transmitted message. The method 600 then ends at 618. In some implementations, the component associated with the transmitted message may attempt to re-transmit the message after a delay or back-off period has elapsed.

At 620, the transmitting component from 602 determines if the node addresses associated with the transmitted message and the colliding message have additional bits that have not been compared. If additional bits do not exist, then the method 600 proceeds to 622. If additional bits exist, the method 600 proceeds to 626.

At 622, the transmitting component from 602 stops transmitting because an error condition may be present. Because components on the communication bus 102 are assigned different node addresses, the bitwise comparison should result in identifying a difference in the values for the node addresses. However, 622 is reached when the component associated with the transmitted message has detected no difference in the bitwise comparison across the entire node addresses associated with each of the transmitted message and the colliding message. Such a situation may occur, for example, when the same node address has erroneously been assigned to multiple components on the communications bus 102, or when the transmitting component from 602 has made an error in the performing the bitwise comparison as part of method 600. In some implementations, the transmitting component from 602 may shut down until reset by a user. In some implementations, the transmitting component from 602 may attempt to re-transmit the message after a delay or back-off period has elapsed. The method ends at 624.

At 626, the transmitting component from 602 may retrieve new bits from the node addresses for the transmitted message and the colliding message. Such new bits may be used to continue the bitwise comparison, and may correspond to those bits located one bit position lower than the bit position of the bits subject to the most recent comparison. The method 600 then proceeds to 608 to continue the bitwise comparison.

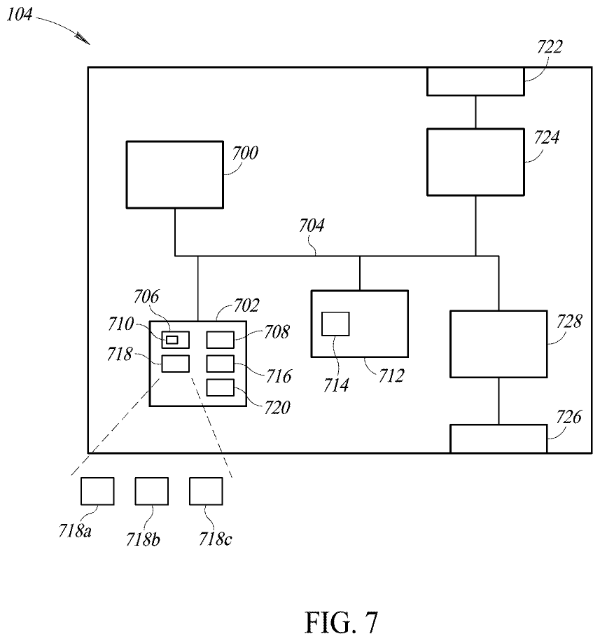

FIG. 7 shows a schematic, block diagram of the control unit 104. The control unit 104 may take the form of any current or future developed computing system capable of executing one or more instruction sets. The control unit 104 includes a processing unit 700, a system memory 702 and a system bus 704 that communicably couples various system components including the system memory 702 to the processing unit 700. The control unit 104 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80x86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit 700 may be any logic processing unit, such as one or more central processing units (CPUs), microprocessors, digital signal processors (DSPs), application-specific integrated circuits (ASICs), field programmable gate arrays (FPGAs), programmable logic controllers (PLCs), etc. Unless described otherwise, the construction and operation of the various blocks shown in FIG. 7 are of conventional design. As a result, such blocks need not be described in further detail herein, as they will be understood by those skilled in the relevant art.

The system bus 704 can employ any known bus structures or architectures, including a memory bus with memory controller, a peripheral bus, and a local bus. The system memory 702 includes read-only memory (“ROM”) 706 and random access memory (“RAM”) 708. A basic input/output system (“BIOS”) 710, which can form part of the ROM 706, contains basic routines that help transfer information between elements within the control unit 104, such as during start-up. Some embodiments may employ separate buses for data, instructions and power.

The control unit 104 also includes one or more internal nontransitory storage systems 712. Such internal nontransitory storage systems 712 may include, but are not limited to, any current or future developed persistent storage device 714. Such persistent storage devices 714 may include, without limitation, magnetic storage devices such as hard disc drives, electromagnetic storage devices such as memristors, molecular storage devices, quantum storage devices, electrostatic storage devices such as solid state drives, and the like.

Program modules can be stored in the system memory 702, such as an operating system 716, one or more application programs 718, other programs or modules, drivers and program data 720.

The application programs 718 may include, for example, one or more machine executable instruction sets (e.g., node address module 718a) capable of assigning node addresses to one or more components, using, for example, some or all of the method 200. The application programs 718 may further include one or more machine executable instructions sets (e.g., identification module 718b) capable of identifying components communicatively coupled to the communications bus 102 and/or determining the associated node addresses, using for example, some or all of the method 300 and the method 400. The application programs 718 may further include one or more machine executable instructions sets (e.g., contention module 718c) capable of determining and acting on priority when two or more data transmissions are present and in contention on the communication bus 102, using, for example, some or all of the method 600.

In some embodiments, the control unit 104 operates in an environment using one or more of the network interfaces 722 and associated network controllers 724 to optionally communicably couple to one or more remote computers, servers, display devices, and/or other devices via one or more communications channels, for example, one or more networks such as the wireless network 122. These logical connections may facilitate any known method of permitting computers to communicate, such as through one or more LANs and/or WANs. Such networking environments are well known in wired and wireless enterprise-wide computer networks, intranets, extranets, and the Internet.

Further, local communication interface 726 and associated controller 728 may be used for establishing communications with other components on the communications bus 102. For example, the local communication interface 726 may be used to communicate cooking instructions to one or more components, such as, for example, first oven rack 106, first oven units 116, configurable rack 108, server and/or server components 118, first workstation 110, and/or first food preparation unit 112. Such a local communication interface 726 may be coupled to a CAN bus, a MOST bus, a FlexRay standard, Society of Automotive Engineers standard SAE J1939, or other similar protocol or standard for communications bus that may be used to communicatively couple devices or components within a vehicle.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

From the foregoing it will be appreciated that, although specific embodiments have been described herein for purposes of illustration, various modifications may be made without deviating from the spirit and scope of the teachings. Accordingly, the claims are not limited by the disclosed embodiments.

The various embodiments described above can be combined to provide further embodiments. U.S. Provisional Application 62/550,438, filed Aug. 25, 2017 is incorporated herein by reference, in its entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1-2. (canceled)

3. The system of claim 7 wherein the instructions, when executed by the at least one processor, further cause the at least one processor to cause the component to perform the detectable controllable action.

4. The system of claim 3 wherein the instructions, when executed by the at least one processor, cause the at least one processor to cause the component to produce at least one of a manifestation, a signal, and an indication as the detectable controllable action.

5. The system of claim 3 wherein the instructions, when executed by the at least one processor, cause the at least one processor to cause the component to at least one of activate or deactivate a light, produce an output of a display screen, generate an aural output, generate a tactile output, open or close a door, or change in temperature.

6. (canceled)

7. A system to operate with a plurality of components which are selectively positionable in respective spaces, the system comprising:
at least one sensor positioned to monitor one or more components when the one or more components are positioned in the respective spaces;
at least one processor communicatively coupled to the at least one sensor to receive signals therefrom;
at least one processor-readable medium communicatively coupled to the at least one processor and that stores processor-executable instructions, the processor-executable instructions, which when executed by the at least one processor, cause the at least one processor to:
for each of a number of the components, in response to a detection of a detectable controllable action from one of the components, store a relationship between a physical location of the space in which the respective component is positioned and a node address via which the respective component is addressed on a communications network, the communications network including one or more nodes that are communicatively coupleable to respective ones of the plurality of components
wherein the instructions, when executed by the at least one processor, cause the at least one processor to query the components for the respective node addresses and the node addresses are randomly generated at the components, and the instructions, when executed by the at least one processor, cause the at least one processor to check for collisions between the randomly generated node addresses received from the components, and in response to detection of a collision between at least two of the received node addresses, to cause a random generation of at least one new node address.

8. A system to operate with a plurality of components which are selectively positionable in respective spaces, the system comprising:
at least one sensor positioned to monitor one or more components when the one or more components are positioned in the respective spaces;
at least one processor communicatively coupled to the at least one sensor to receive signals therefrom;
at least one processor-readable medium communicatively coupled to the at least one processor and that stores processor-executable instructions, the processor-executable instructions, which when executed by the at least one processor, cause the at least one processor to:
for each of a number of the components, in response to a detection of a detectable controllable action from one of the components, store a relationship between a physical location of the space in which the respective component is positioned and a node address via which the respective component is addressed on a communications network, the communications network including one or more nodes that are communicatively coupleable to respective ones of the plurality of components
wherein the instructions, when executed by the at least one processor, cause the at least one processor to query the components for the respective node addresses and the node addresses are randomly generated at the components, and the instructions, when executed by the at least one processor, cause the at least one processor to check for collisions between the randomly generated node addresses received from the components, and in response to detection of a collision between at least two of the received node addresses, to cause a random generation of new node addresses for each of the components.

9. The system of claim 8 wherein the instructions, when executed by the at least one processor, cause the at least one processor to rebroadcast the query to all nodes on the communications network in order to cause the random generation of at least one new node address.

10. The system of claim 7 wherein the instructions, when executed by the at least one processor, cause the at least one processor to broadcast the query to all nodes on the communications network.

11-22. (canceled)

23. The method of claim 27, further comprising: causing the at least one processor to transmit signals that cause the component to perform the detectable controllable action.

24. The method of claim 23 wherein the component is caused to produce at least one of a manifestation, a signal, or an indication as the detectable controllable action.

25. The method of claim 23 wherein the component is caused to at least one of activate or deactivate a light, produce an output of a display screen, generate an aural output, generate a tactile output, open or close a door, or change a temperature.

26. (canceled)

27. A method of operating a system with a plurality of components which are selectively positionable in respective spaces, the method comprising:
monitoring via data received from at least one sensor one or more components positioned in the respective spaces;
detecting a detectable controllable action from one of the components;
in response to detecting the detectable controllable action from one of the components, storing a relationship between a physical location of the respective space in which the respective component is positioned and a node address via which the respective component is addressed on a communications network, the communications network including one or more nodes that are communicatively coupleable to respective ones of the plurality of components;
querying the components for the respective node addresses, wherein the node addresses are randomly generated at the components; and
checking for collisions between the randomly generated node addresses received from the components, and in response to detecting a collision between at least two of the received node addresses, causing a random generation of at least one new node address.

28. A method of operating a system with a plurality of components which are selectively positionable in respective spaces, the method comprising:
monitoring via data received from at least one sensor one or more components positioned in the respective spaces;
detecting a detectable controllable action from one of the components;
in response to detecting the detectable controllable action from one of the components, storing a relationship between a physical location of the respective space in which the respective component is positioned and a node address via which the respective component is addressed on a communications network, the communications network including one or more nodes that are communicatively coupleable to respective ones of the plurality of components;
querying the components for the respective node addresses, wherein the node addresses are randomly generated at the components; and
checking for collisions between the randomly generated node addresses received from the components, and in response to detecting a collision between at least two of the received node addresses, causing a random generation of new node addresses for each of the components.

29. The method of claim 28, further comprising: rebroadcasting the query to all nodes on the communications network in order to cause the random generation of at least one new node address.

30. The method of claim 27 wherein querying further comprises broadcasting the query to all nodes on the communications network.

31-40. (canceled)

41. The system of claim 8 wherein the instructions, when executed by the at least one processor, cause the at least one processor to broadcast the query to all nodes on the communications network.

42. The system of claim 8 wherein the instructions, when executed by the at least one processor, further cause the at least one processor to cause the component to perform the detectable controllable action.

43. The system of claim 8 wherein the instructions, when executed by the at least one processor, cause the at least one processor to cause the component to produce at least one of a manifestation, a signal, and an indication as the detectable controllable action.

44. The system of claim 8 wherein the instructions, when executed by the at least one processor, cause the at least one processor to cause the component to at least one of activate or deactivate a light, produce an output of a display screen, generate an aural output, generate a tactile output, open or close a door, or change in temperature.

45. The method of claim 28, further comprising: causing the at least one processor to transmit signals that cause the component to perform the detectable controllable action.

46. The method of claim 28 wherein the component is caused to produce at least one of a manifestation, a signal, or an indication as the detectable controllable action.

47. The method of claim 28 wherein the component is caused to at least one of activate or deactivate a light, produce an output of a display screen, generate an aural output, generate a tactile output, open or close a door, or change a temperature.

48. The method of claim 28 wherein querying further comprises broadcasting the query to all nodes on the communications network.
